(19) United States
(12) Patent Application Publication
(10) Pub. No.: US 2013/0175789 A1
(43) Pub. Date: Jul. 11, 2013

(54) FOLDING CART

(71) Applicant: Pei-Lung LU, Tainan City (TW)

(72) Inventor: Pei-Lung LU, Tainan City (TW)

(21) Appl. No.: 13/348,340

(22) Filed: Jan. 11, 2012

(51) Int. Cl. B62B 3/02

(52) U.S. Cl. 280/639

(57) ABSTRACT

A folding cart includes a tray, a chassis frame and a plurality of independent and foldable support frames. Each support frame has a first support member and a second support member with ends pivotally coupled with each other. The other ends of the first support member and the second support member have pivot member for pivotally coupling pivoting portions of the tray and the chassis frame respectively, so that the tray, the chassis frame and the support frames jointly form an accommodating space. When the support frames are folded, the pivotally coupled ends of the first support member and the second support member are accommodated in the accommodating space. The first support member and the second support member are pivotally coupled by a special pivoting structure for adjusting the height of the folding cart, and the folding cart further has a moving element for moving the folding cart.

### BACKGROUND OF THE INVENTION

1. Field of the Invention

The present invention relates to a folding cart, in particular to the folding cart with independent foldable support frames.

2. Description of the Related Art

During the growth of most human beings, it is inevitable to go through the stage of learning how to walk, and babies around six months old usually start learning how to walk. Traditionally, babies learn walking without relying on any tool, but there is a possibility of making the body of a baby or child dirty or injuring the baby or child easily, so that parents let babies use baby walkers to learn how to walk.

However, the conventional baby walkers generally do not come with any adjusting structure, but babies and children grow faster than we expect, thus the height of the baby walkers usually cannot match with their height. In addition, modern people always buy things with considerations in economics, and the baby walkers without an adjusting structure cannot be used repeatedly thus cause a financial burden to the parents. In addition, the baby walkers with the adjusting structure available in the market usually add additional components to the conventional baby walkers, so as to increase the weight of the baby walkers and cause inconvenience to transportation. Furthermore, the conventional baby walkers usually do not come with the simple folding function, therefore, when the baby walker is not in use, parents have to find a way to store the baby walkers in a convenient manner.

In view of the aforementioned problems of the prior art, the inventor of the present invention based on years of experience in the related industry to conduct extensive researches and experiments, and finally developed a folding cart in accordance with the present invention to overcome the problems of the prior art.

### SUMMARY OF THE INVENTION

In view of the problems of the prior art, it is a primary objective of the present invention to provide a folding cart to overcome the trouble of folding a baby walker and enhance the repeated use of the baby walker.

To achieve the foregoing objective, the present invention provides a folding cart comprising a tray, a chassis frame and a plurality of independent and foldable support frames, wherein the tray has a through hole and a plurality of tray pivoting portions, and the chassis frame also has a plurality of chassis pivoting portions. The through hole is provided for passing a baby walk learner into the folding cart. The tray pivoting portion is provided for pivotally coupled to one end of the support frame, and the other end of the support frame is pivotally coupled to a chassis pivoting portion of the chassis frame. In addition, the quantity of the independent foldable support frames of the folding cart can be two, three, four, or more. Each support frame has a first support member and a second support member, and a first end of the first support member and a first end of the second support member are pivotally coupled to each other. In addition, a second end of the first support member and a second end of the second support member have a pivot member, and the first support member and the second support member are respectively and pivotally coupled to the tray pivoting portion of the tray and the chassis pivoting portion of the chassis frame correspondingly, so that the tray, the chassis frame and the support frames jointly form an accommodating space inside the folding cart. When the support frame of the folding cart is folded, the mutually and pivotally coupled first ends of the first support member and the second support member of the support frame are accommodated into the accommodating space.

Therefore, the feature of the folding cart of the present invention resides on that the first support member and the second support member in each of the support frames are mutually and pivotally coupled to each other, so that each support frame can be independently folded inward.

More specifically, a rotating shaft is disposed at the first end of the first support member of the support frames, and a slot is disposed at the first end of the second support member for movably and pivotally coupling the first end of the first support member to the first end of the second support member. In addition, a stop portion is further disposed at the first end of the second support member. When it is desired to fold the folding cart, the stop portion is provided for stopping the rotating shaft at the first end of the first support member, so as to prevent the first support member and the second support member of each support frame from being separated.

Therefore, another feature of the folding cart of the present invention resides on that the interaction between the rotating shaft and the slot can be used to achieve the effect of folding the support frames independently.

In addition, the second support member further has a support member accommodating space, such that when the folding cart is assembled, the support member accommodating space can be used for accommodating the first support member to adjust the length of the support frame in the folding cart. For example, the first support member has one latching element, and the second support member has a plurality of latching elements. The depth of accommodating the first support member in the support member accommodating space of the second support member can be adjusted, so that the latching element of the first support member can be correspondingly latched to different latching elements of the second support member to adjust and fix the length of the support frames.

Accordingly, a further feature of the folding cart of the present invention resides on that the relative positions of the first support member and the second support member, and the latch of the latching element of the first support member with various latching elements of the second support member can be used for adjusting the total length of the support frames, so as to adjust the height of the folding cart.

The folding cart further comprises a plurality of moving elements coupled to the bottom of the folding cart and provided for moving the folding cart. Wherein, the moving elements can be wheels.

In summation of the description above, the folding cart of the present invention has one or more of the following advantages:

(1) Since the first support member and the second support member of each support frame are pivotally coupled with each other, each support frame can be independently folded inward to achieve the effect of folding the folding cart conveniently.

(2) Since the relative positions of the first support member and the second support member, and the reciprocal latching between the latching elements at different positions, the overall length of the support frames can be adjusted so as to adjust the height of the folding cart.

The technical characteristics of the present invention will become apparent with the detailed description of the preferred embodiments accompanied with the illustration of related drawings as follows.

### BRIEF DESCRIPTION OF THE DRAWINGS

FIG. 1 is a schematic stereogram of a folding cart of the present invention when the folding cart is unfolded;

FIG. 2 is a schematic stereogram of a folding cart of the present invention when the folding cart is folded;

FIG. 3 is a schematic view of a tray of a folding cart of the present invention;

FIG. 4 is a schematic view of the pivotal connection of a tray pivoting portion with a support frame of a folding cart of the present invention;

FIG. 5 is a schematic view of the pivotal connection of a chassis pivoting portion with a support frame of a folding cart of the present invention;

FIG. 6 is a schematic view of two support members assembled to a folding cart of the present invention;

FIG. 7 is a schematic view of the pivotal connection of two support members of a folding cart of the present invention; and

FIG. 8 is a schematic view of an adjusting device of a folding cart of the present invention.

### DETAILED DESCRIPTION OF THE PREFERRED EMBODIMENTS

It is noteworthy to point out that the drawings are provided for the purpose of illustrating the present invention, but they are not necessarily drawn according to the actual scale, or are intended for limiting the scope of the invention.

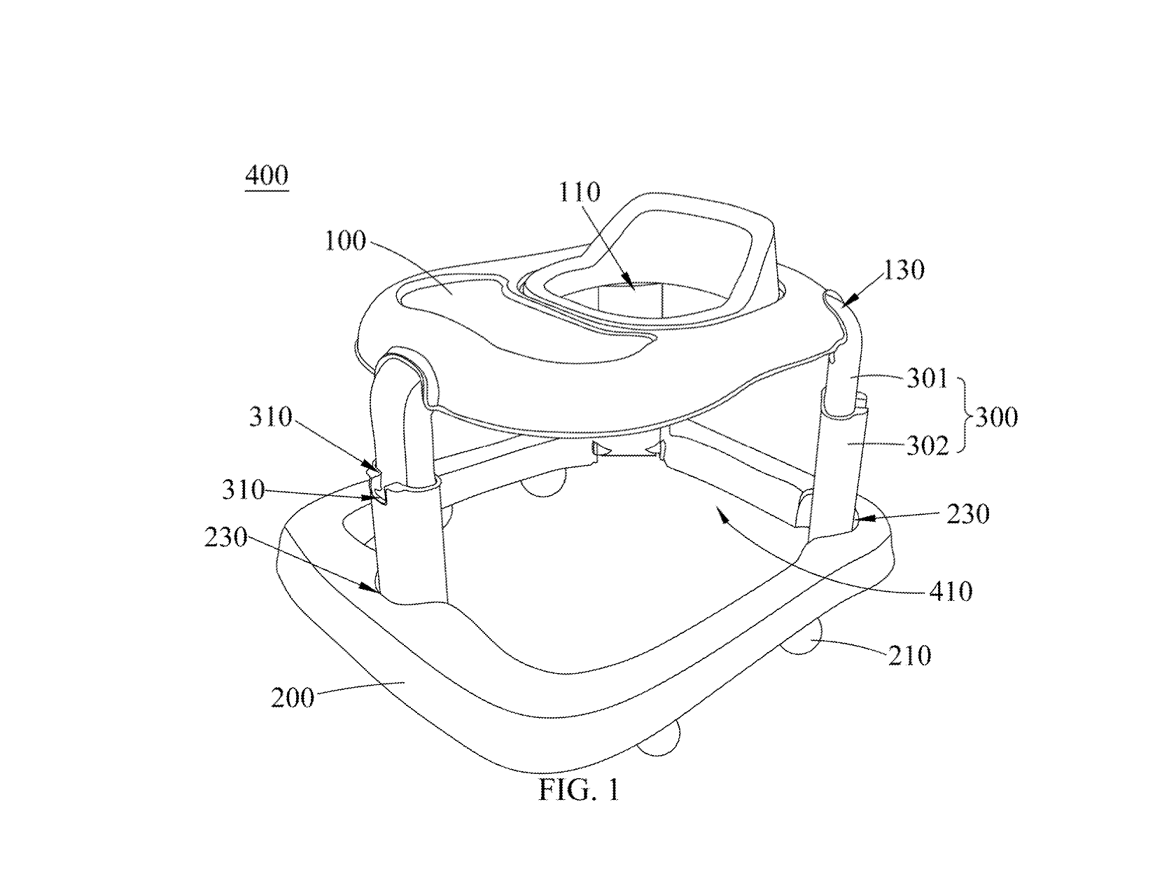

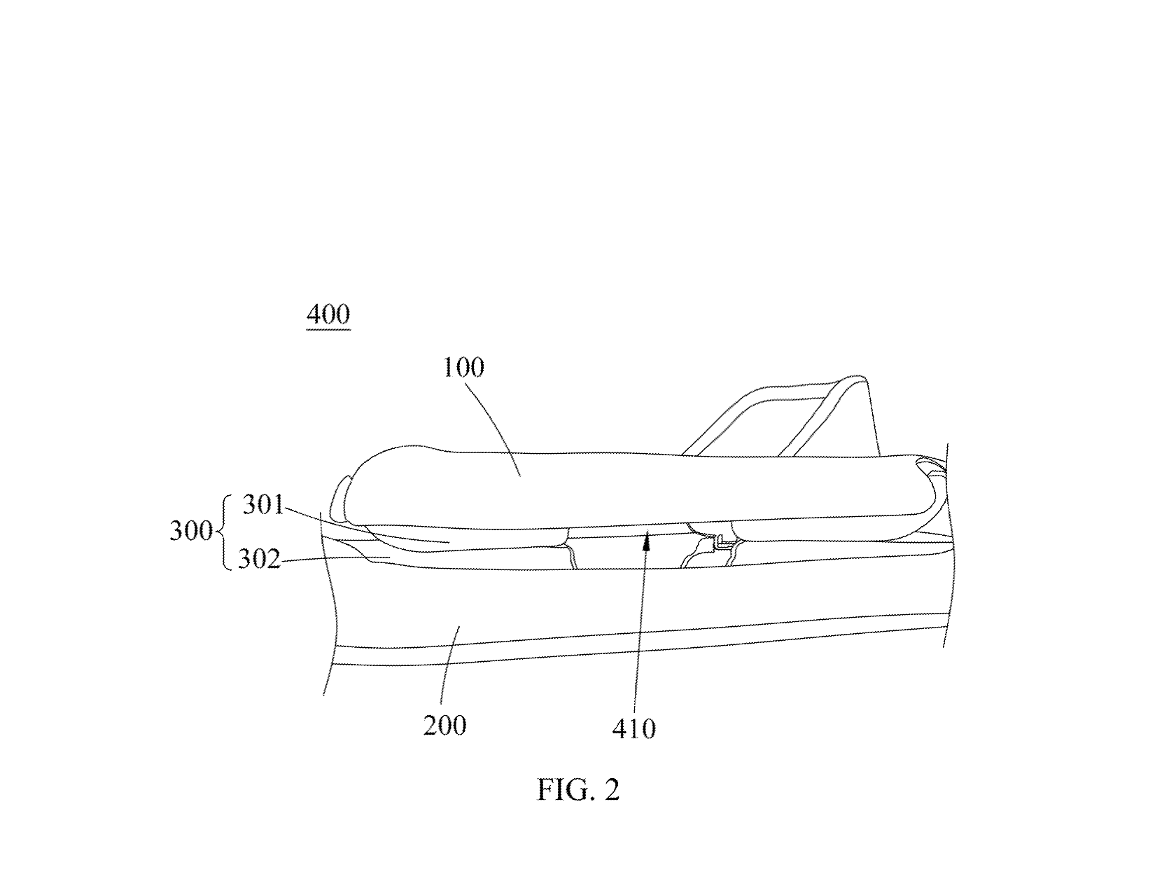

With reference to FIGS. 1 and 2 for schematic stereogram of a folding cart of the present invention when the folding cart is unfolded and folded respectively, the folding cart 400 comprises a tray 100, a chassis frame 200 and a plurality of independent and foldable support frames 300. Wherein, the tray 100 comprises a through hole 110 and a tray pivoting portion 130, and the chassis frame 200 has a chassis pivoting portion 230. In addition, the quantity of support frames 300 can be two, three, four, or more, and each support frame 300 includes a first support member 301 and a second support member 302. One end of the first support member 301 and one end of the second support member 302 have a folding portion 310 respectively, and the folding portions 310 are pivotally coupled to each other. The other end of the first support member 301 and the other end of the second support member 302 are respectively and pivotally coupled to the tray pivoting portion 130 and the chassis pivoting portion 230. When the folding cart 400 is unfolded, the tray 100, the chassis frame 200 and the support frames 300 jointly form an accommodating space 410. When the folding cart 400 is folded, the pivotally coupled ends of the first support member 301 and the second support member 302 are accommodated in the accommodating space 410. In addition, the folding cart 400 further comprises a plurality of moving elements 210 such as wheels, and the moving elements 210 are provided for moving the folding cart 400. Wherein, the moving elements 210 can be coupled to the bottom of the chassis frame 200.

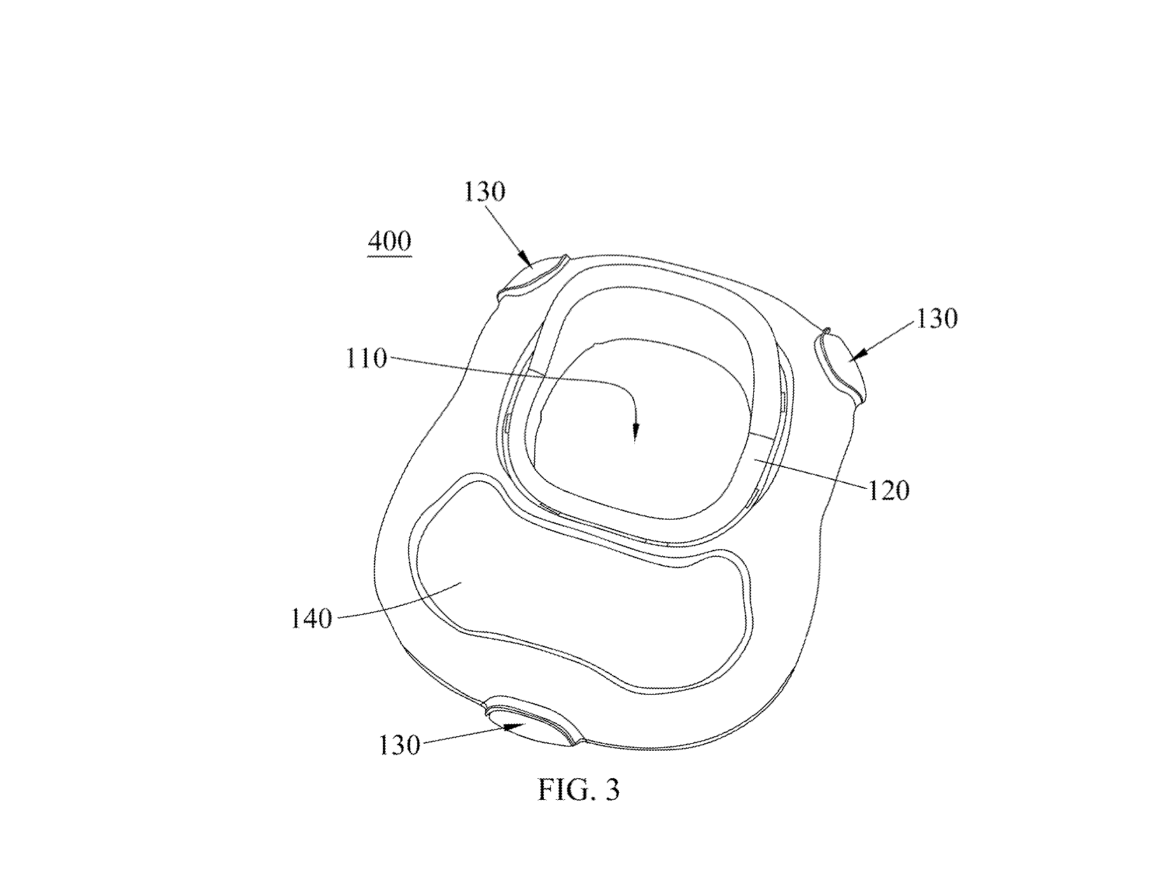

With reference to FIG. 3 for a schematic view of a tray 100 of a folding cart of the present invention, the tray 100 further comprises an inner frame 120 in addition to the through hole 110 and the tray pivoting portion 130. Wherein, the through hole 110 is provided for passing a baby walk learner into the folding cart 400, and the inner frame 120 is disposed at the periphery of the through hole 110 of the tray 100 and made of a soft material for protecting the baby. Further, the front area of the tray 100 can be a compartment area 140 provided for putting toys or dining tools when the baby plays or eats.

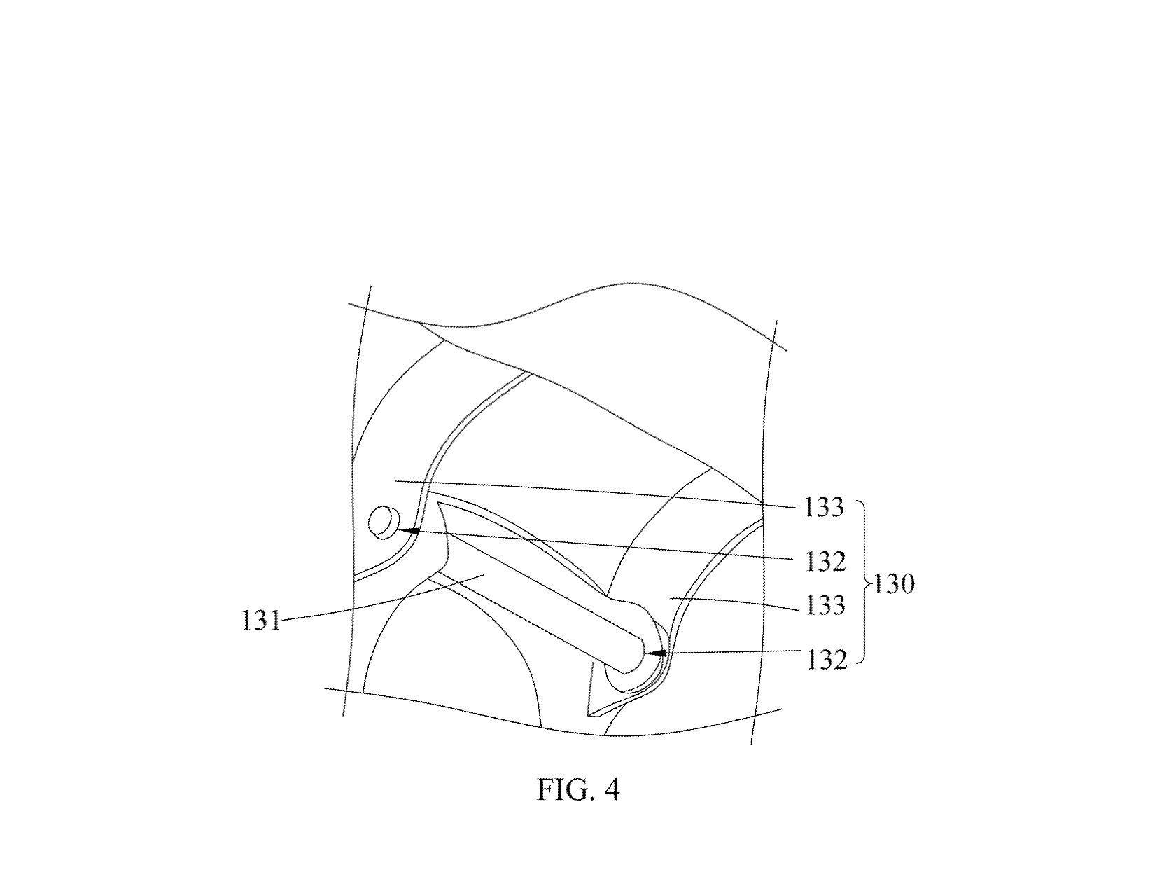

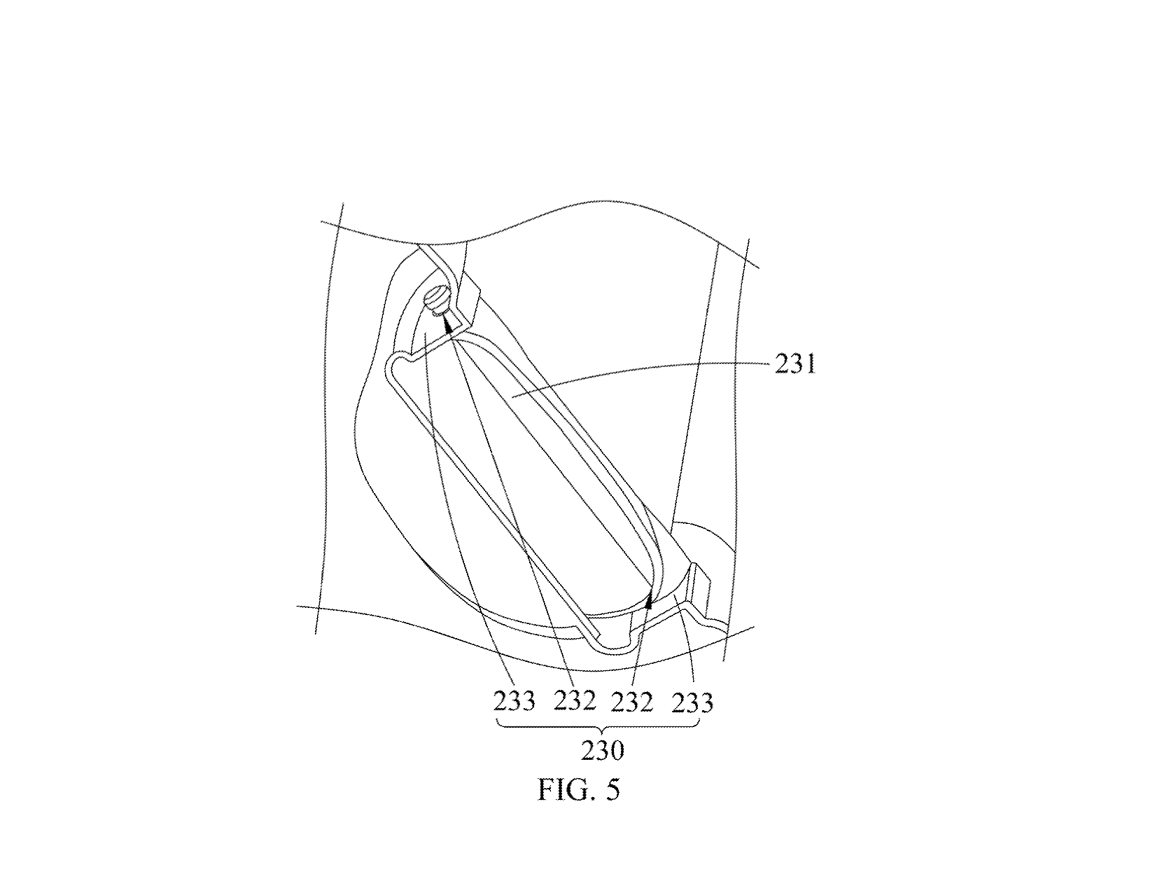

With reference to FIGS. 4 and 5 for a schematic view of the pivotal connection of a tray pivoting portion with a support frame and the pivotal connection of a chassis pivoting portion with a support frame of a folding cart of the present invention respectively, the tray pivoting portion 130 is comprised by two connecting elements 133 extended downward from the tray 100. Each of the two connecting elements 133 has a hole 132, and the two holes 132 are separated with a distance apart from each other and provided for pivotally coupling to the support frame 300. The two connecting elements 133 can be integrally formed with the tray 100 or connected to the tray 100, and the two connecting elements 133 can be made of the same material or different materials from the material of the tray 100. More specifically, a pivot member 131 is disposed at one end of the support frame 300, and the pivot member 131 can be a rotating shaft with both ends inserted into the holes 132 respectively, so that the support frame 300 may be pivotally coupled to the tray pivoting portion 130 of the tray 100. In addition, as shown in FIG. 5, two connecting elements 233 are disposed in each chassis pivoting portion 230 as well, and the two connecting elements 233 are separated with a distance apart from each other. Each of the two connecting elements 233 has a corresponding hole 232 for pivotally coupling to the pivot member 231 situated at the other end of the support frame 300. Wherein, the pivot member 231 can be a rotating shaft with both ends inserted into the holes 232 respectively, so that the support frame 300 is pivotally coupled to the chassis pivoting portion 130 of the chassis frame 200.

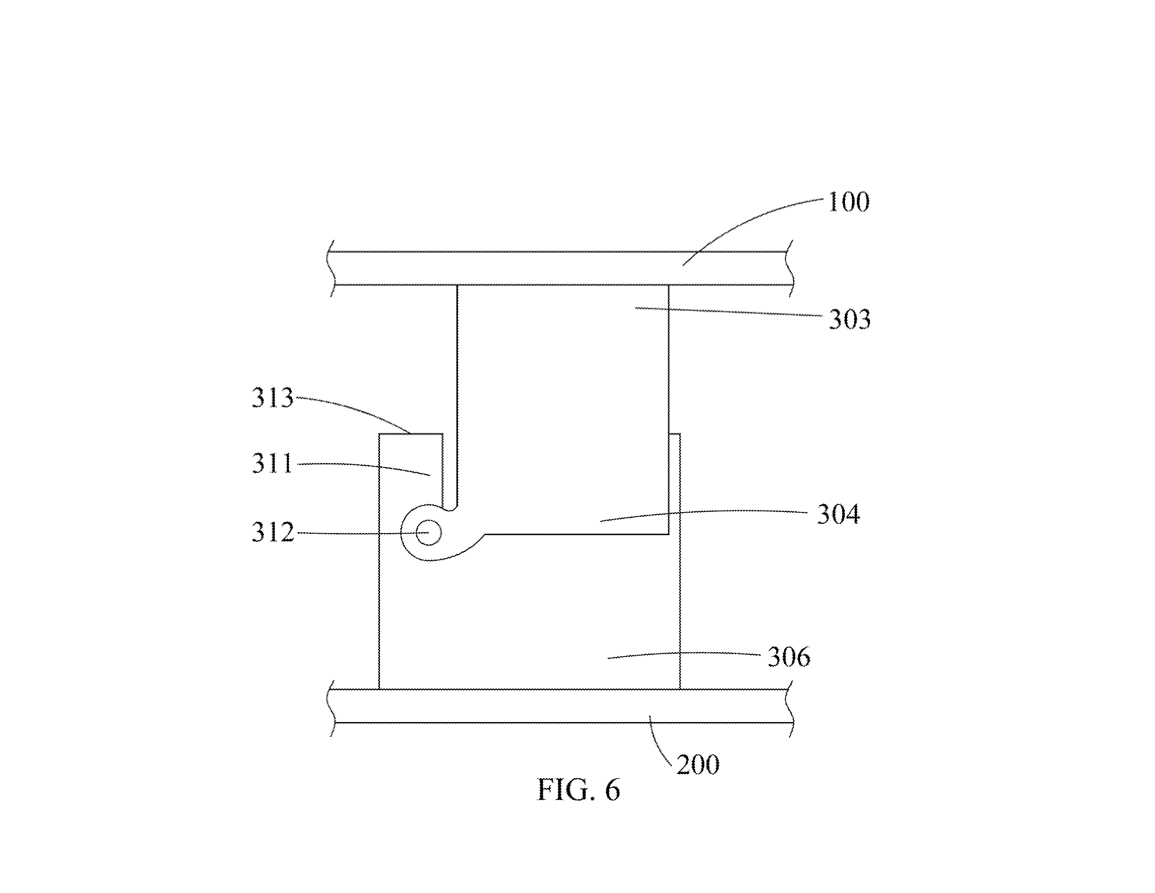

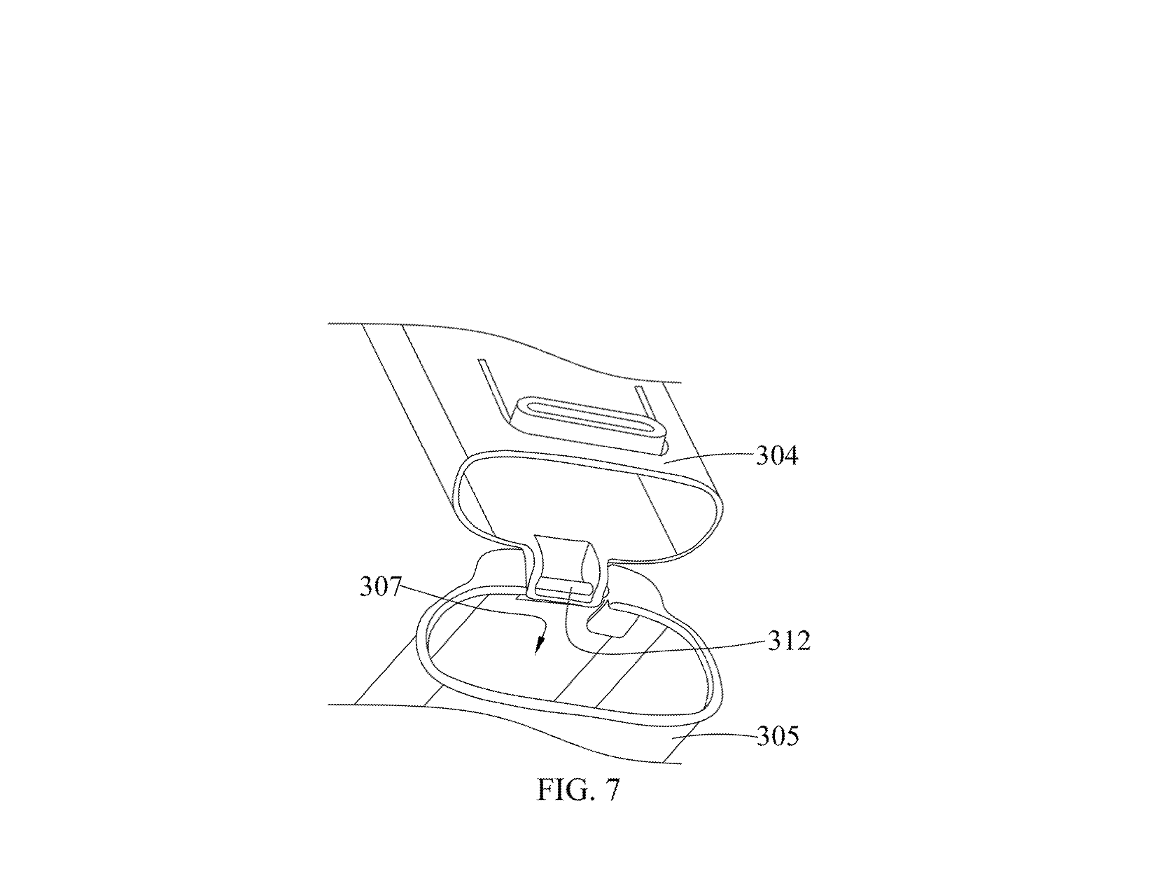

With reference to FIGS. 6 and 7 for a schematic view of two support members assembled to a folding cart of the present invention and a schematic view of the pivotal connection of the two support members of the folding cart of the present invention respectively, the first support member 301 and the second support member 302 are pivotally coupled with each other. As shown in FIGS. 1, 6 and 7, each support frame 300 includes a first support member 301 and a second support member 302, wherein a second end 303 of the first support member 301 and a tray pivoting portion 130 of the tray 100 are pivotally coupled to each other, and the second end 306 of the second support member 302 and the chassis pivoting portion 230 of the chassis frame 200 are pivotally coupled to each other. In addition, the first end 304 of the first support member 301 and the first end 305 of the second support member 302 are pivotally coupled to each other, and a special structure is provided for folding the folding cart 400.

More specifically, the first end 304 of the first support member 301 has a rotating shaft 312, and the first end 305 of the second support member 302 has a slot 311, so that the first end 304 of the first support member 301 and the first end 305 of the second support member 302 can be movably and pivotally coupled to each other through the rotating shaft 312 and the slot 311. When it is desired to fold the folding cart 400, the first support member 301 and the second support member 302 are moved in opposite direction at first. For example, the first support member 301 is moved upward, and the second support member 302 is moved downward, so as to separate the first end 304 of the first support member 301 from the first end 305 of the second support member 302. Then, the first end 304 of the first support member 301 and the first end 305 of the second support member 302 are accommodated in the accommodating space 410. In addition, a stop portion 313 is further disposed at the first end 305 of the second support member 302 to prevent the first support member 301 and the second support member 302 from being separated. Wherein, the stop portion 313 can be a transverse plate disposed at the top of the slot 311 for stopping the rotating shaft 312 from moving upward continuously.

When it is needed to use the folding cart 400, the first end 304 of the first support member 301 can be accommodated in the support member accommodating space 307 of the second support member 302 for adjusting the overall length of the support frames 300 by the depth of the first end 304 of the first support member 301 accommodated in the support member accommodating space 307.

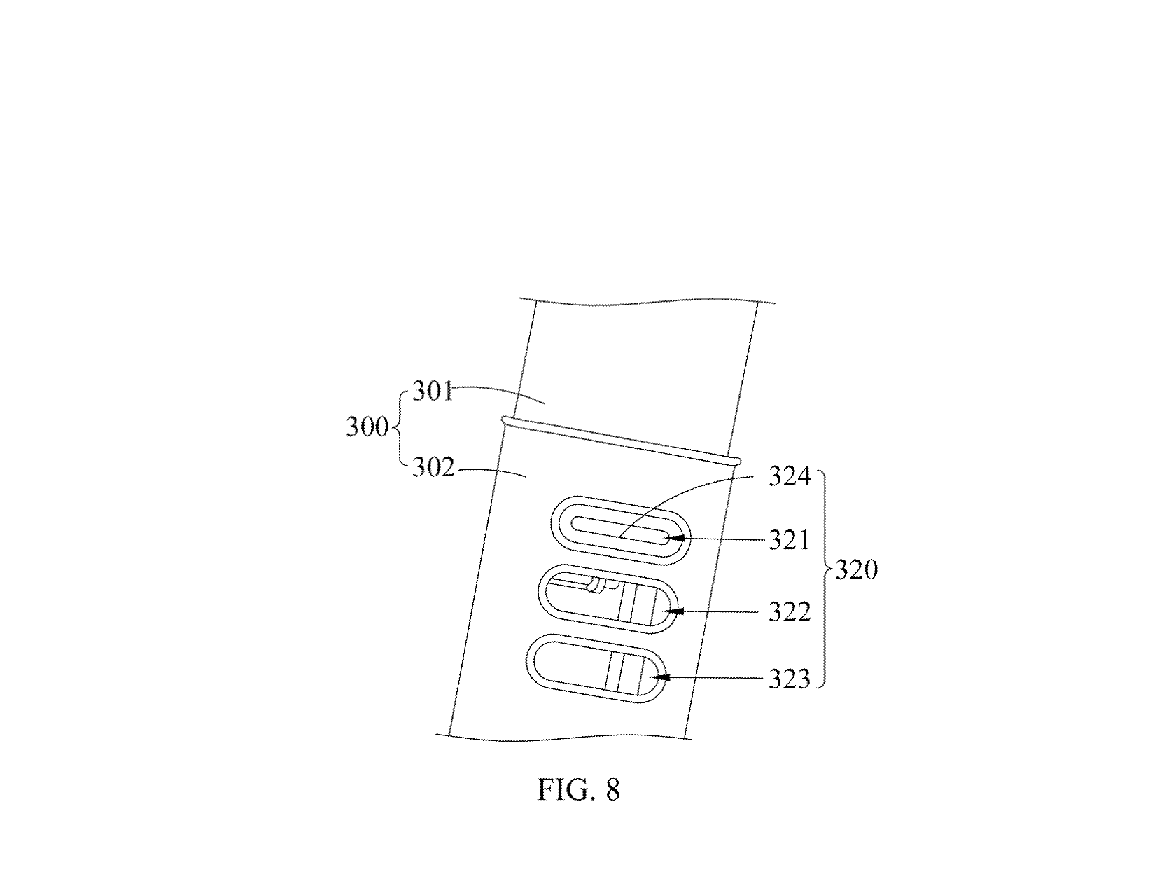

With reference to FIG. 8 for a schematic view of an adjusting device of a folding cart of the present invention, the adjusting device 320 includes a plurality of latching elements 321, 322, 323 and a latching element 324. Wherein, the latching element 324 is disposed on the first support member 301, and the latching elements 321, 322, 323 are disposed on the second support member 302. For example, the latching element 324 can be a protruding object formed by outward extending from the first support member 301, and the corresponding latching elements 321, 322, 323 can be holes formed on the second support member 302. Accordingly, the protruding object of the first support member 301 can be latched into the holes of the second support member 302 to adjust and fix the length of the support frame 300. Since the latching element 324 can be latched into any one of the latching elements 321, 322 or 323 disposed at different positions, the latching element 324 can be latched to various latching elements 321, 322, 323 to adjust and fix the length of the support frame 300.

While the invention has been described by means of specific embodiments, numerous modifications and variations could be made thereto by those skilled in the art without departing from the scope and spirit of the invention set forth in the claims.

What is claimed is:

1. A folding cart, comprising:
a tray, having a through hole and a plurality of tray pivoting portions;
a chassis frame, having a plurality of chassis pivoting portions; and
a plurality of independent and foldable support frames, each support frame having a first support member and a second support member, and a first end of the first support member and a first end of the second support member being pivotally coupled to each other, and a second end of the first support member and a second end of the second support member have pivot members respectively and pivotally coupled to the tray pivoting portions of the tray and the chassis pivoting portions of the chassis frame correspondingly, such that the tray, the chassis frame and the support frames jointly form an accommodating space;
wherein when the support frames are folded, the mutually and pivotally coupled first ends of the first support member and the second support member are accommodated in the accommodating space.

2. The folding cart of claim 1, wherein a length of the support frames is adjustable.

3. The folding cart of claim 1, wherein a rotating shaft is disposed at the first end of the first support member, and a slot is formed at the first end of the second support member for movably and pivotally coupling the first end of the first support member to the first end of the second support member.

4. The folding cart of claim 3, wherein a stop portion is further disposed at the first end of the second support member to prevent the first support member and the second support member from being separated.

5. The folding cart of claim 4, wherein the second support member further has a support member accommodating space for accommodating the first support member to adjust the length of the support frames.

6. The folding cart of claim 5, wherein the first support member includes a latching element, and the second support member includes a plurality of latching elements, and the depth of accommodating the first support member in the support member accommodating space is adjustable, so that the latching element of the first support member is correspondingly latched to one of the latching elements of the second support member to adjust and fix the length of the support frames.

7. The folding cart of claim 1, further comprising a plurality of moving elements coupled to the bottom of the chassis frame for moving the folding cart.

8. The folding cart of claim 7, wherein the moving elements are wheels.
